(19) United States
(12) Patent Application Publication
(10) Pub. No.: US 2024/0193847 A1
(43) Pub. Date: Jun. 13, 2024

(54) EFFICIENT SPATIOTEMPORAL RESAMPLING USING PROBABILITY DENSITY FUNCTION SIMILARITY

(71) Applicant: ADVANCED MICRO DEVICES, INC., Santa Clara, CA (US)

(72) Inventor: Yusuke Tokuyoshi, Tokyo (JP)

(21) Appl. No.: 18/076,496

(22) Filed: Dec. 7, 2022

(51) Int. Cl. G06T 15/06; G06T 3/40

(52) U.S. Cl. CPC G06T 15/06; G06T 3/40

(57) ABSTRACT

A processor shares path tracing data across sampling locations to amortize computations across space and time. The processor maps a group of sampling locations of a frame that are adjacent to each other to a reservoir. Each reservoir is associated with a ray that intersects subsets of path space such as a pixel. The processor resamples the reservoirs based on a similarity of probability density functions (PDFs) between pixels to select a set of samples mapped to the reservoir. The processor then performs resampling of the selected set of samples to obtain a representative light sample to determine a value for each pixel and renders the frame based on the values of the pixels.

### BACKGROUND

Virtual reality (VR) systems use interactive applications to simulate different types of environments. VR systems seek to provide a realistic visual experience to immerse users in these simulated environments and artificially create sensory experiences for the users. The visual experience is made more realistic by displaying what users expect to see, in real-time, throughout their experience. The realistic experience is facilitated by displaying the video data with high visual quality (e.g., high definition) and low latency (the amount of time for the data to traverse VR sub-systems and/or VR devices). When the visual quality is lacking or latency of the data increases, the realism of the visual experience may be negatively affected.

Ray tracing is a technique for generating an image by tracing the path of light as pixels in an image plane and simulating the effects of interactions between the light and virtual objects. By extension, path tracing is a technique for shooting multiple rays per pixel in random directions and can be used to solve more complex lighting situations. Path tracing relies on the use of Monte Carlo methods of solving a rendering equation. Path tracing produces images that are more realistic as a function of the number of light samples used per pixel, but as the number of light samples increases, so does the computational expense. In addition, real-time rendering of dynamic scenes constrains the amount of time to build and update data structures for light sampling.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an illustration of a scene in which light is reflected off objects to a user's eye in accordance with some embodiments.

FIG. 2 is a diagram of a set of sampling locations of a frame mapped to a reservoir containing samples for path tracing in accordance with some embodiments.

FIG. 3 is a flow diagram of a method of reducing the reuse of samples from spatially neighboring pixels for importance sampling based on a similarity of probability density functions between the neighboring pixels in accordance with some embodiments.

FIG. 4 is an illustration of an average of visible light directions in a scene in accordance with some embodiments.

FIG. 5 is an illustration of a reduction of the loss of sharp shadow details for one ray per pixel using a reduced reuse of samples based on a similarity of PDFs between pixels in accordance with some embodiments.

FIG. 6 is an illustration of a reduction of darkening bias for two rays per pixel using a reduced reuse of samples based on a similarity of PDFs between pixels in accordance with some embodiments.

FIG. 7 is an illustration of a reduction of variance on shadow edges for three rays per pixels using a reduced reuse of samples based on a similarity of PDFs between pixels in accordance with some embodiments.

FIG. 8 is a block diagram of a processing system for performing reduction of reuse of samples based on a similarity of PDFs between pixels for path tracing in accordance with some embodiments in accordance with some embodiments.

### DETAILED DESCRIPTION

A processing system performs ray and path tracing by shooting rays from a camera toward a scene and intersecting the rays with the scene geometry to construct light paths. As objects are hit, the processing system generates new rays on the surfaces of the objects to continue the paths. The processing system computes color values for each of the rays and determines the values of pixels of an image for display based on the color values.

Monte Carlo path tracing is a technique for tracing paths of light through pixels on an image plane in which the color of a pixel is computed by randomly sampling light paths that connect the camera to light sources through multiple interactions with the scene. Averaging the intensities of many samples for a pixel produces a noisy estimate of the total illumination of the pixel. Whereas offline rendering used for applications such as movies uses thousands of shadow-casting light rays, or samples, per pixel, to perform real-time rendering, the processing system can trace only a few rays at each pixel due to time, power, and memory constraints. Therefore, the samples that are selected for each pixel impact the quality of the resulting image.

When a ray reaches a surface in a computer-generated scene, the ray can split into one or more additional rays, such as reflected, refracted, and shadow rays. For example, a ray reflected from a perfectly specular surface can be traced in a mirror-reflection direction from a point corresponding to where an incoming ray reaches the surface. The closest object that the reflected ray intersects can be what will be seen in the reflection. By contrast, a refracted ray can be traced in a different direction than the reflected ray, such as when a refracted ray goes into a surface. For another example, a shadow ray can be traced toward each light. If an opaque object is located between the surface and the light, the surface can be in shadow and the light may not illuminate the surface.

Rather than uniformly sampling rays to use, a bidirectional reflectance distribution function (BRDF) can be used to determine how light is reflected off a surface. The BRDF describes the distribution that an incoming ray of light is scattered in a random outgoing direction. If a material is more diffuse and less specular, the BRDF will be wider, indicating more directions to sample. When more sampling directions are required, the computation cost for path tracing may increase.

For direct lighting from emissive objects, a visibility term to explain direct lighting with shadow-ray visibility test in the domain of lighting positions is given by:

L=∫_{Ω}V(x)*BRDF*(emitted radiance of light source at position x)*(geometry term)dx (1)

where x is the world-space position, Ω represents positions of the light sources, and the geometry term=cosine/distance².

Because direct sampling proportional to the integral is infeasible, the processing system uses resampled importance sampling (RIS) to sample approximately proportional to the product of some of the terms of the rendering equation by generating M≥1 candidate samples x={xᵢ, . . . , x_{M}} from a source distribution p that is suboptimal but easy to sample from, such as p∝Lₑ and a target probability density function (PDF) such as \hat{p}∝ the integrand, where Lₑ represents emitted radiance. Resampling is a method of repeat sampling from a given sample to estimate the precision of the sample by drawing randomly from a set of data points. RIS randomly chooses an index z∈{1, . . . , M} from the pool of candidates, each having an associated resampling weight w(xᵢ), using discrete probabilities:

$$p ( z \vert x ) = \frac{w ( {x}_{z} )}{{\sum }_{i = 1}^{M} w ( {x}_{i} )} with w ( x ) = \frac{\hat{p} ( x )}{p ( x )} . \qquad ( 3 )$$

where \hat{p}(x) is a desired target PDF for which no practical sampling algorithm may exist. A sample y≡x_{z} is then selected and used in the 1-sample RIS estimator:

$${〈 L 〉}_{ris}^{1 , M} = \frac{f ( y )}{\hat{p} ( y )} \cdot ( \frac{1}{M} {\sum }_{j = 1}^{M} w ( {x}_{j} ) ) . \qquad ( 4 )$$

Repeating RIS multiple times and averaging the results yields an N-sample RIS estimator:

$${〈 L 〉}_{ris}^{N , M} = {\sum }_{i = 1}^{N} m ( {y}_{i} ) ( \frac{f ( {y}_{i} )}{\hat{p} ( {y}_{i} )} \cdot ( \frac{1}{M} {\sum }_{j = 1}^{M} w ( {x}_{ij} ) ) ) . \qquad ( 5 )$$

In some embodiments, m(yᵢ) is constant (i.e., 1/N), and in other embodiments m(yᵢ) is calculated based on the multiple importance sampling method. Thus, resampled importance sampling generates M “low quality” samples from p into x={xᵢ, . . . , x_{M}}, computes a normalized CDF for x using

$$w = \frac{\hat{p}}{p} ,$$

draws a random index z from x, and uses a sample y≡x_{z} to calculate direct lighting. However, for higher quality results, M must be as large as possible, which adversely impacts the amount of computation and storage required. Spatiotemporal reservoir resampling (ReSTIR) increases the number of sample candidates by reusing candidates at neighboring pixels. For example, ReSTIR looks for reservoirs for resampling in spatially neighboring pixels and temporally neighboring pixels in a previous frame. However, ReSTIR can increase errors such as bias and variance when the difference of target PDFs between neighboring pixels is large. Reusing pixels whose target PDFs are not similar to the current pixel increases variance (noise). By using a heuristic that estimates the similarity of target PDFs between pixels, the errors are reduced further than error reduction based on depth and surface normals.

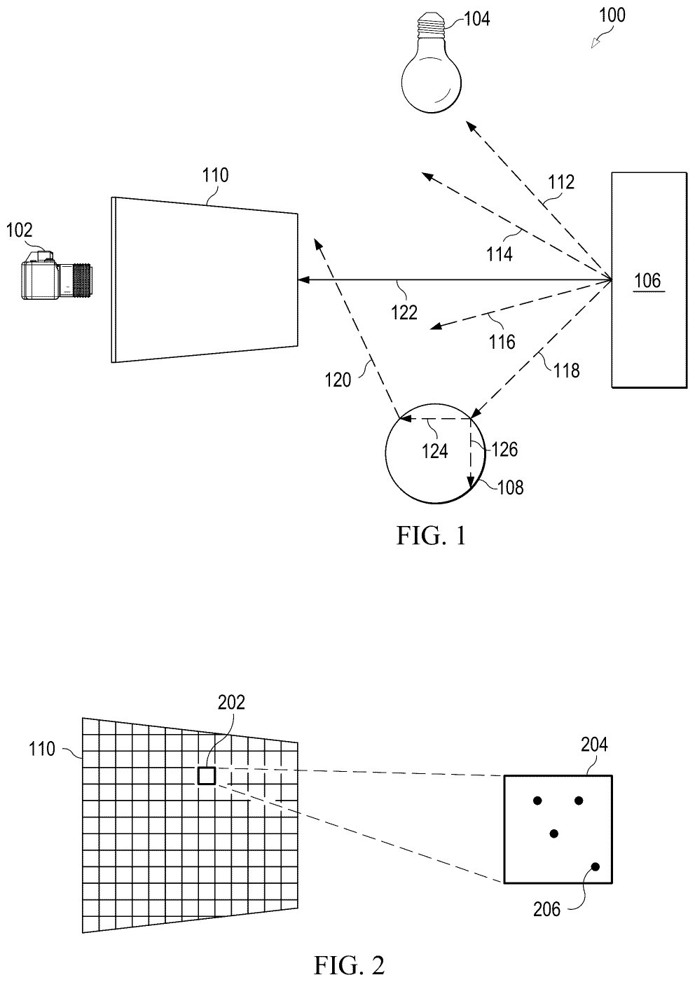

FIGS. 1-8 illustrate techniques for reusing samples from spatially neighboring pixels for ReSTIR based on the similarity of PDFs between pixels, leading to reduced variance (noise) and bias. A processor of a processing system renders a frame of a video stream using single-bounce path connection such as direct lighting and final gathering by mapping sampling locations of a frame of a video stream, storing one or more rays that intersect the mapped sampling locations, estimating PDFs for neighboring pixels, comparing the estimated PDFs, resampling the one or more rays to select a set of samples of points of the one or more rays that intersect the mapped sampling locations based on the comparison of estimated PDFs, and rendering the frame based on the selected set of samples. In some embodiments, the processor approximates the sample distribution for each pixel using the von Mises-Fisher (vMF) distribution (i.e., a normalized spherical Gaussian) and computes the similarity of two vMF distributions between pixels using an analytical solution.

In some embodiments, data structures referred to as “reservoirs” are each associated with a ray that intersects a subset of path space such as a pixel. Each reservoir stores a currently selected light sample and resampling information such as a running sum of weights applied to each sample and other properties of the selected light sample. The processor resamples the reservoirs by combining and re-using reservoirs across neighboring pixels based on the similarity of PDFs between pixels and corresponding pixels of the previous frame to select a set of samples mapped to the pixel. The processor then performs resampling of the selected set of samples to obtain a representative light sample to determine a value for the pixel.

Because the similarity of PDFs does not have an analytical solution, in some embodiments, the processor approximates the PDFs for each pixel with a vMF distribution and analytically computes the similarity of two vMF distributions between pixels. In some embodiments, the vMF distribution for each pixel is based on a weighted average of past sample directions for the pixel. In some embodiments, the vMF distributions are based on computing an average direction of rays that intersect sampling locations at the second pixel based on a sum of weighted directions divided by a sum of weights. If the similarity of vMF distributions is low, the processor rejects the pixel from reuse in some embodiments or assigns a low reuse weight to the pixel for RIS in other embodiments. By using this rejection heuristic, the processor reduces the error of ReSTIR.

In some embodiments, the processor generates initial reservoirs for each sampling location and stores the initial reservoirs, as described in more detail below. The processor then performs separate passes of resampling to improve the light sample selection for each sampling location, both spatially—by looking for neighbors in the current frame—and temporally—by looking for neighbors in the previous frame. The processor performs a random selection of a few reservoirs for each sampling location. The processor determines a weight for the samples for each pixel based on the similarity of PDFs of sampling locations for each spatially neighboring pixel compared to PDFs of sampling locations for the current pixel. The processor then performs resampling by looking at each selected reservoir one by one and determining whether to select a light sample from the reservoir based on the weight of the pixel associated with the sample. The succession of random decisions results in a better light sample and therefore less noise in the final image with much fewer rays. The processor then denoises the frame and renders the frame for display.

FIG. 1 illustrates a scene 100 in world-space in which light is reflected off objects 106, 108 through a frame 110 of pixels to a camera 102 in accordance with some embodiments. Path tracing simulates light transport by tracing rays that connect the surfaces of light sources and a camera sensor, represented as the camera 102 in FIG. 1, through a three-dimensional scene 100. The scene 100 is represented by surfaces of objects 106, 108 and the scattering properties of the objects 106, 108. When a light ray interacts with the objects 106, 108, a new segment of the path is generated. The point of intersection of a light ray with the surface of an object 106, 108 is a world-space sampling location. Direct lighting occurs when a primary ray intersects the sampling location, and indirect lighting occurs after the first bounce (e.g., via reflections if the first bouse is specular or global illumination if the first bounce is diffuse). Although photons travel from emissive surfaces, for path tracing, paths are generated starting from the camera 102 and bounce off objects 106, 108 in the scene 100 until they encounter a light source 104. Because optical systems are reversible, tracing the paths from the camera 102 until they reach the light source 104 produces the same results as if paths were generated starting from the light source 104 until they reach the camera 102.

In the illustrated example, a ray 122 is projected from the camera 102 through the frame 110 into the scene 100, where the ray 122 encounters the object 106. The object 106 is partially reflective, and new segments 112, 114, 116, 118 scatter from the object 106 back into the scene 100. New segments 112, 114, 116, 118 represent only a subset of the infinite light rays that are reflected off the object 106, but given limitations on computational power, time, and memory, segments 112, 114, 116, 118, may be used as samples of the light rays that are reflected off the object 106. Segment 118 is reflected off the object 106 toward the object 108, which represents a glass sphere, which generates reflection and internal refraction rays (not shown), one of which travels through the object 108 to spawn more refraction rays, including ray 120.

The value a processor (not shown) uses to render each pixel of the frame 110 is based on the rays of light intersecting surfaces of objects 106, 108 in the scene 100. The rays intersecting each sampling location can come from an infinite number of directions; if a ray spawned from a position on the surface of an object 106, 108 reaches a light, the position is lit, and otherwise the position is not lit. To simplify the calculation of the value of each sampling location, the processor takes samples over the domain of the region of space from which light can be gathered using Monte Carlo sampling. Thus, to account for the fact that light at a sampling location point P (not shown) can come from anywhere in a hemisphere between a light source and the point P, the processor selects random samples (directions) within the hemisphere oriented around the point P and traces rays in these random directions into the scene 100. The Monte Carlo sampling generates more accurate results as the number of samples increases, but as the number of samples and the number of bounces increases, the calculations become exponentially more resource intensive.

To facilitate highly accurate path tracing using fewer samples per pixel, the processor shares sample information across neighboring (adjacent) sampling locations and reuses the samples for RIS. FIG. 2 is a diagram of a set 202 of sampling locations 202 of the frame 110 mapped to a reservoir (not shown) containing samples (e.g., sample 206) for path tracing in accordance with some embodiments. The processor groups adjacent (“neighboring”) sampling locations into sets and assigns the groups of sampling locations to different reservoirs. The number of sampling locations in the set 202 is a matter of design choice and varies from one embodiment to another.

To reduce the error, particularly on shadow edges, of ReSTIR, the processor accounts for differences in shadow visibilities, the difference of BRDFs, light intensities, and light distances in the target PDFs of spatially neighboring pixels by reducing the reuse of samples from spatially neighboring pixels in proportion to the dissimilarity of target PDFs of the spatially neighboring pixels.

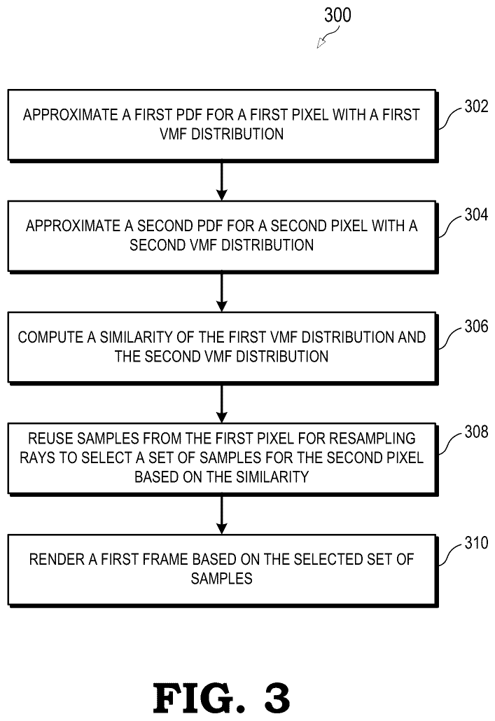

FIG. 3 is a flow diagram of a method 300 of reducing the reuse of samples from spatially neighboring pixels for resampled importance sampling based on a similarity of probability distribution functions between the neighboring pixels in accordance with some embodiments. The similarity of two PDFs is represented as r_{s,j}, where

$${r}_{s , j} = {( \frac{{\int }_{Ω} {\hat{p}}_{s} ( x ) {\hat{p}}_{j} ( x ) d x}{\sqrt{{\int }_{Ω} {( {\hat{p}}_{s} ( x ) )}^{2} d x} \sqrt{{\int }_{Ω} {( {\hat{p}}_{j} ( x ) )}^{2} d x}} )}^{β} \qquad ( 6 )$$

and β is a user-specified constant (e.g., β=20) to control the sharpness of the similarity. The target PDF \hat{p}ₛ(x)∝(light intensity)*(geometry term)*(BSDF)*(visibility). However, there is no analytical solution for r_{s,j}. The distribution of light samples given by ReSTIR is approximately equal to the target PDF with visibility. Thus, the processor approximates the sample distribution using a von Mises-Fisher (vMF), also known as a spherical Gaussian. The similarity of vMFs has an analytical solution.

At block 302, the processor approximates a first PDF for a first pixel (i.e., a pixel that is spatially adjacent to a current pixel) with a first vMF distribution. The vMF distribution is obtained by the average of sample directions ω̅ₛ, where

$${\overline{ω}}_{s} = \frac{{\int }_{Ω} {ω}_{s} ( x ) {\hat{p}}_{s} ( x ) d x}{{\int }_{Ω} {\hat{p}}_{s} ( x ) d x} \approx \frac{{\sum }_{j} {ω}_{j} ( {y}_{j} ) m ( {y}_{j} ) \frac{{p}_{s} ( {y}_{j} )}{{p}_{j} ( {y}_{j} )} {V}_{j} ( {y}_{j} ) \frac{1}{M} {\sum }_{i}^{M} \frac{p ( {x}_{i} )}{q ( {x}_{i} )}}{{\sum }_{j} m ( {y}_{j} ) \frac{{p}_{s} ( {y}_{j} )}{{p}_{j} ( {y}_{j} )} {V}_{j} ( {y}_{j} ) \frac{1}{M} {\sum }_{i}^{M} \frac{p ( {x}_{i} )}{q ( {x}_{i} )}} \qquad ( 7 )$$

and ωⱼ(yⱼ) is the direction of light yⱼ viewed from pixel j (i.e., direction reuse), Σⱼ is temporal resampling, and M is the number of initial candidate samples for each frame. In some embodiments, the processor stores the average of sample directions ω̅ₛ for each pixel in additional reservoirs. The vMF approximation reuses initial directions similar to visibility reuse but has no spatial reuse for sharp shadows. The estimation of the vMF distribution gives a center axis of the vMF distribution

$${ν}_{s} = \frac{{\overline{ω}}_{s}}{‖ {\overline{ω}}_{s} ‖} \qquad ( 8 )$$

and a sharpness of the vMF distribution

$${λ}_{s} = \frac{‖ {\overline{ω}}_{s} ‖ ( 3 - {‖ {\overline{ω}}_{s} ‖}^{2} )}{1 - {‖ {\overline{ω}}_{s} ‖}^{2}} . \qquad ( 9 )$$

At block 304, the processor approximates a PDF for a second pixel (i.e., the current pixel) with a second vMF distribution in a similar manner to the approximation of the PDF for the first pixel described above with respect to block 302.

At block 306, the processor computes a similarity r_{s,j} of the first vMF distribution and the second vMF distribution:

$${r}_{s , j} = {( \frac{2 \sqrt{{λ}_{s} {λ}_{j}}}{{λ}_{s} + {λ}_{j}} )}^{β} exp ( \frac{β {λ}_{s} {λ}_{j}}{{λ}_{s} + {λ}_{j}} ( ( {ν}_{s} \cdot {ν}_{j} ) - 1 ) ) \qquad ( 10 )$$

At block 308, the processor calculates and applies a weight m(yᵢ) to candidate samples based on the similarity for reuse for RIS. The weight m(yᵢ) is a value between 0 and 1 that is monotonically increasing with the similarity between vMFs.

$$m ( {y}_{i} ) = \frac{{r}_{s , j} {M}_{j} {\hat{p}}_{j} ( {y}_{j} )}{{\sum }_{k} {r}_{s , k} {M}_{k} {\hat{p}}_{k} ( {y}_{k} )} \qquad ( 11 )$$

The rejection heuristic reduces the amount of spatial reuse in proportion to the dissimilarity between vMFs and multiplies the number of reused candidates Mⱼ by the similarity r_{s,j} for MIS. The processor thus reuses samples from the first pixel for resampling rays to select a set of samples for the second pixel based on the similarity of vMFs (and, by extension, PDFs) between the first pixel and the second pixel.

In some embodiments, the processor uses the immediately preceding frame in a stream of video frames for additional samples for temporal re-use. After rendering a frame, the processor stores each sampling location's final reservoir for re-use in the next frame. By rendering frames sequentially and storing the final reservoirs for reuse in the next frame, each frame combines reservoirs with all previous frames in a sequence, resulting in improved image quality and temporal stability. However, in cases of a change in camera angle or a scene change between frames (i.e., temporal disocclusion), where a pixel has no corresponding pixel in the preceding frame, the reuse of temporally neighboring pixels will result in high variance (noise). The temporally estimated average direction ω̅ₛ can have high variance for such disocclusion. Therefore, the estimated PDF similarity can be inaccurate, and the spatial reuse based on this inaccurate similarity can increase the error in the resulting image. To prevent spatial reuse based on inaccurate similarity, the processor blends a known geometry-based heuristic r_{s,j}^{geo} with the PDF-based heuristic r_{s,j}p^{df} according to the temporal candidate count M′ₛ:

$${r}_{s , j} = {r}_{s , j}^{pdf} c + {r}_{s , j}^{geo} ( 1 - c ) \qquad ( 12 )$$

$$where c = min ( max ( \frac{{M}_{s}^{′} - M}{{M}_{m ax} - M} , 0 ) , 1 ) \qquad ( 13 )$$

and Mₘₐₓ is the maximum number of candidates for temporal reuse. In cases of temporal disocclusion, M′ₛ=0.

In some embodiments, the processor stochastically shoots shadow rays only in cases of temporal disocclusion. The probability of shooting a shadow ray is given by

$$\frac{{r}_{s , j}^{geo} ( 1 - c )}{{r}_{s , j}^{pdf} c + {r}_{s , j}^{geo} ( 1 - c )} . \qquad ( 14 )$$

At block 310, the processor renders the frame for display based on the selected sets of samples for each pixels.

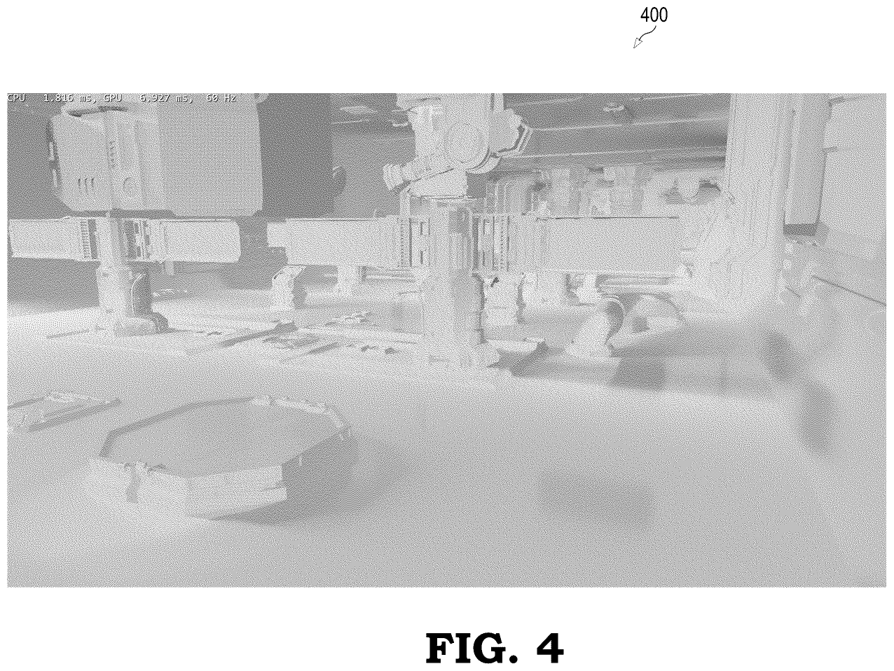

FIG. 4 is an illustration 400 of an average of visible light directions ω̅ₛ in a scene in accordance with some embodiments. The data for the direct visualization 400 is stored at an image buffer reservoir in some embodiments.

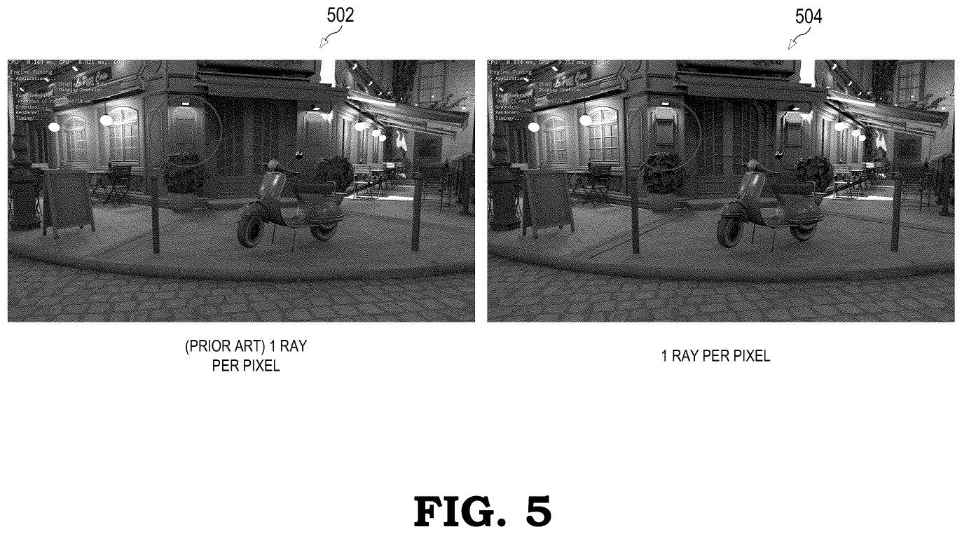

FIG. 5 is an illustration of a reduction of the loss of sharp shadow details for one ray per pixel when using a reduced reuse of samples based on a similarity of PDFs between pixels in accordance with some embodiments. Example frame 502 shows the loss of sharp shadow details when using previous methods, because the shadows become blurred when samples from spatially neighboring pixels having dissimilar PDFs are reused for RIS. By contrast, example frame 504 retains sharp shadow details by reducing the reuse of samples having dissimilar PDFs between pixels.

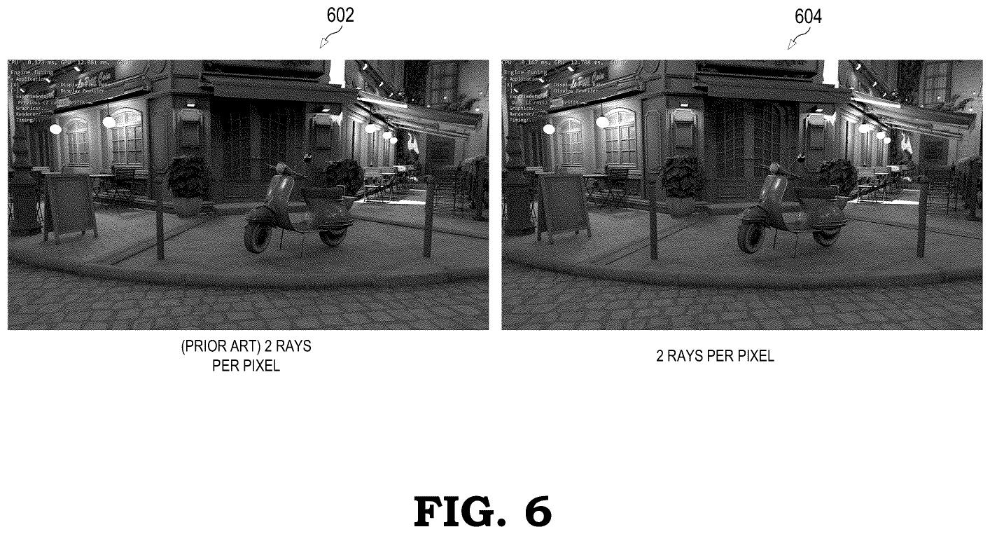

FIG. 6 is an illustration of a reduction of darkening bias for two rays per pixel using a reduced reuse of samples based on a similarity of PDFs between pixels in accordance with some embodiments. Example frame 602 shows the darkening bias that occurs when using previous methods, because pixels in soft shadows carry over to neighboring pixels when samples from spatially neighboring pixels having dissimilar PDFs are reused for RIS. By contrast, example frame 604 reduces the darkening bias by reducing the reuse of samples having dissimilar PDFs between pixels.

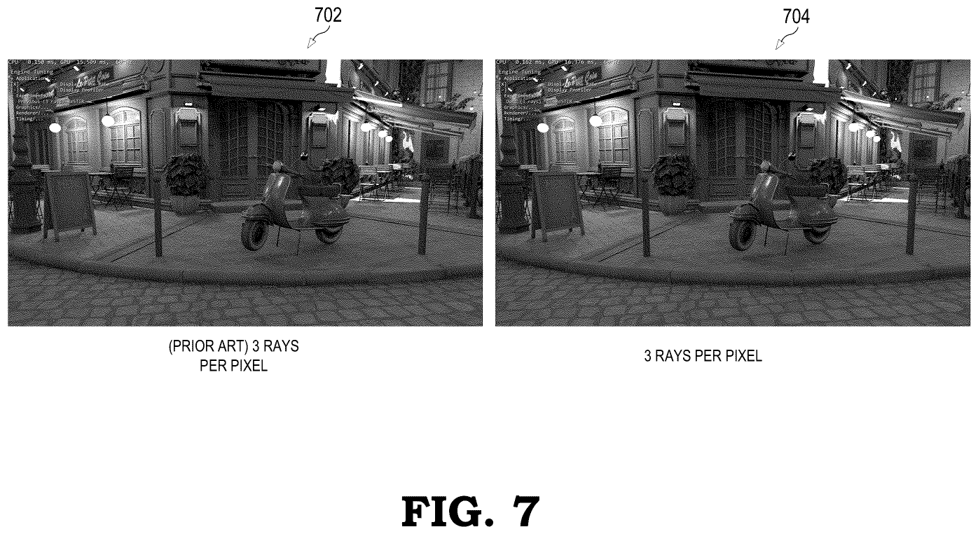

FIG. 7 is an illustration of a reduction of variance on shadow edges for three rays per pixels using a reduced reuse of samples based on a similarity of PDFs between pixels in accordance with some embodiments. Example frame 702 shows variance at shadow edges that is visible as noise when using previous methods, because the PDFs around shadow edges become blurred when samples from spatially neighboring pixels having dissimilar PDFs are reused for RIS. By contrast, example frame 704 reduces the variance on shadow edges by reducing the reuse of samples having dissimilar PDFs between pixels.

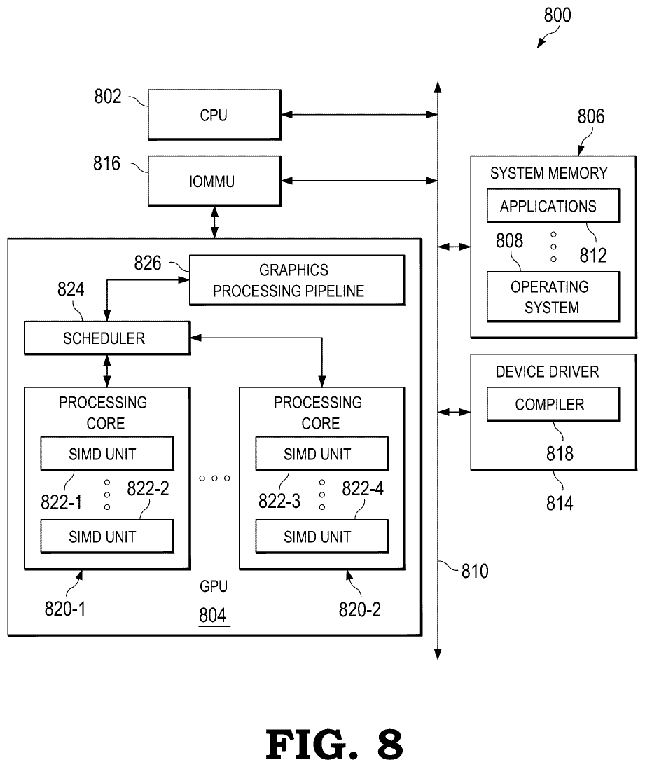

The techniques described herein are, in different embodiments, employed at any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). Referring now to FIG. 8, a block diagram of a processing system 800 is illustrated in accordance with some embodiments, configured with parallel processors. The processing system 800 includes a central processing unit (CPU) 802 and a graphics processing unit (GPU) 804. In at least some embodiment, the CPU 802, the GPU 804, or both the CPU 802 and GPU 804 are configured to efficient spatiotemporal resampling using the similarity of PDFs between spatially neighboring pixels. The CPU 802, in at least some embodiments, includes one or more single- or multi-core CPUs. In various embodiments, the GPU 804 includes any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

In the embodiment of FIG. 8, the CPU 802 and the GPU 804 are formed and combined on a single silicon die or package to provide a unified programming and execution environment. This environment enables the GPU 804 to be used as fluidly as the CPU 802 for some programming tasks. In other embodiments, the CPU 802 and the GPU 804 are formed separately and mounted on the same or different substrates. It should be appreciated that processing system 800, in at least some embodiments, includes more or fewer components than illustrated in FIG. 8. For example, the processing system 800, in at least some embodiments, additionally includes one or more input interfaces, non-volatile storage, one or more output interfaces, network interfaces, and one or more displays or display interfaces.

As illustrated in FIG. 8, the processing system 800 also includes a system memory 806, an operating system 808, a communications infrastructure 810, and one or more applications 812. Access to system memory 806 is managed by a memory controller (not shown) coupled to system memory 806. For example, requests from the CPU 802 or other devices for reading from or for writing to system memory 806 are managed by the memory controller. In some embodiments, the one or more applications 812 include various programs or commands to perform computations that are also executed at the CPU 1002. The CPU 802 sends selected commands for processing at the GPU 804. The operating system 808 and the communications infrastructure 810 are discussed in greater detail below. The processing system 800 further includes a device driver 814 and a memory management unit, such as an input/output memory management unit (IOMMU) 816. Components of processing system 800 are implemented as hardware, firmware, software, or any combination thereof. In some embodiments, the processing system 800 includes one or more software, hardware, and firmware components in addition to or different from those shown in FIG. 8.

Within the processing system 800, the system memory 806 includes non-persistent memory, such as DRAM (not shown). In various embodiments, the system memory 806 stores processing logic instructions, constant values, variable values during execution of portions of applications or other processing logic, or other desired information. For example, in various embodiments, parts of control logic to perform one or more operations on CPU 802 reside within system memory 806 during execution of the respective portions of the operation by CPU 802. During execution, respective applications, operating system functions, processing logic commands, and system software reside in system memory 806. Control logic commands that are fundamental to operating system 808 generally reside in system memory 806 during execution. In some embodiments, other software commands (e.g., a set of instructions or commands used to implement a device driver 814) also reside in system memory 806 during execution of processing system 800.

The IOMMU 816 is a multi-context memory management unit. As used herein, context is considered the environment within which the kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 816 includes logic to perform virtual to physical address translation for memory page access for devices, such as the GPU 804. In some embodiments, the IOMMU 816 also includes, or has access to, a translation lookaside buffer (TLB) (not shown). The TLB is implemented in a content addressable memory (CAM) to accelerate translation of logical (i.e., virtual) memory addresses to physical memory addresses for requests made by the GPU 804 for data in system memory 806.

In various embodiments, the communications infrastructure 810 interconnects the components of the processing system 800. Communications infrastructure 810 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some embodiments, communications infrastructure 810 also includes an Ethernet network or any other suitable physical communications infrastructure that satisfies an application's data transfer rate requirements. Communications infrastructure 810 also includes the functionality to interconnect components, including components of the processing system 1000.

A driver, such as device driver 814, communicates with a device (e.g., GPU 804) through an interconnect or the communications infrastructure 810. When a calling program invokes a routine in the device driver 814, the device driver 814 issues commands to the device. Once the device sends data back to the device driver 814, the device driver 814 invokes routines in an original calling program. In general, device drivers are hardware-dependent and operating-system-specific to provide interrupt handling required for any necessary asynchronous time-dependent hardware interface. In some embodiments, a compiler 818 is embedded within device driver 814. The compiler 818 compiles source code into program instructions as needed for execution by the processing system 800. During such compilation, the compiler 818 applies transforms to program instructions at various phases of compilation. In other embodiments, the compiler 818 is a standalone application. In various embodiments, the device driver 814 controls operation of the GPU 804 by, for example, providing an application programming interface (API) to software (e.g., applications 812) executing at the CPU 802 to access various functionality of the GPU 804.

The CPU 802 includes (not shown) one or more of a control processor, field-programmable gate array (FPGA), application-specific integrated circuit (ASIC), or digital signal processor (DSP). The CPU 802 executes at least a portion of the control logic that controls the operation of the processing system 800. For example, in various embodiments, the CPU 802 executes the operating system 808, the one or more applications 812, and the device driver 814. In some embodiments, the CPU 802 initiates and controls the execution of the one or more applications 812 by distributing the processing associated with one or more applications 812 across the CPU 802 and other processing resources, such as the GPU 804.

The GPU 804 executes commands and programs for selected functions, such as graphics operations and other operations that are particularly suited for parallel processing. In general, GPU 804 is frequently used for executing graphics pipeline operations, such as pixel operations, geometric computations, and rendering an image to a display. In some embodiments, GPU 804 also executes compute processing operations (e.g., those operations unrelated to graphics such as video operations, physics simulations, computational fluid dynamics, etc.), based on commands or instructions received from the CPU 802. For example, such commands include special instructions that are not typically defined in the instruction set architecture (ISA) of the GPU 804. In some embodiments, the GPU 804 receives an image geometry representing a graphics image, along with one or more commands or instructions for rendering and displaying the image. In various embodiments, the image geometry corresponds to a representation of a two-dimensional (2D) or three-dimensional (3D) computerized graphics image.

In various embodiments, the GPU 804 includes one or more compute units, such as one or more processing cores 820 (illustrated as 820-1 and 820-2) that include one or more single-instruction multiple-data (SIMD) units 822 (illustrated as 822-1 to 822-4) that are each configured to execute a thread concurrently with execution of other threads in a wavefront by other SIMD units 822, e.g., according to a SIMD execution model. The SIMD execution model is one in which multiple processing elements share a single program control flow unit and program counter and thus execute the same program but are able to execute that program with different data. The processing cores 820 are also referred to as shader cores or streaming multi-processors (SMXs). The number of processing cores 820 implemented in the GPU 804 is configurable. Each processing core 820 includes one or more processing elements such as scalar and or vector floating-point units, arithmetic and logic units (ALUs), and the like. In various embodiments, the processing cores 820 also include special-purpose processing units (not shown), such as inverse-square root units and sine/cosine units.

Each of the one or more processing cores 820 executes a respective instantiation of a particular work item to process incoming data, where the basic unit of execution in the one or more processing cores 820 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing core 820.

The GPU 804 issues and executes work-items, such as groups of threads executed simultaneously as a “wavefront”, on a single SIMD unit 822. Wavefronts, in at least some embodiments, are interchangeably referred to as warps, vectors, or threads. In some embodiments, wavefronts include instances of parallel execution of a shader program, where each wavefront includes multiple work items that execute simultaneously on a single SIMD unit 822 in line with the SIMD paradigm (e.g., one instruction control unit executing the same stream of instructions with multiple data). A scheduler 824 is configured to perform operations related to scheduling various wavefronts on different processing cores 820 and SIMD units 822 and performing other operations to orchestrate various tasks on the GPU 804.

To reduce latency associated with off-chip memory access, various GPU architectures include a memory cache hierarchy (not shown) including, for example, L1 cache and a local data share (LDS). The LDS is a high-speed, low-latency memory private to each processing core 820. In some embodiments, the LDS is a full gather/scatter model so that a workgroup writes anywhere in an allocated space. In some embodiments, the memory cache hierarchy stores the average of visible light directions ω̅ₛ for each pixel, as illustrated in FIG. 4.

The parallelism afforded by the one or more processing cores 820 is suitable for graphics-related operations such as pixel value calculations, vertex transformations, tessellation, geometry shading operations, and other graphics operations. A graphics processing pipeline 826 accepts graphics processing commands from the CPU 802 and thus provides computation tasks to the one or more processing cores 820 for execution in parallel. Some graphics pipeline operations, such as pixel processing and other parallel computation operations, require that the same command stream or compute kernel be performed on streams or collections of input data elements. Respective instantiations of the same compute kernel are executed concurrently on multiple SIMD units 822 in the one or more processing cores 820 to process such data elements in parallel. As referred to herein, for example, a compute kernel is a function containing instructions declared in a program and executed on an accelerated processing device (APD) processing core 820. This function is also referred to as a kernel, a shader, a shader program, or a program.

In at least some embodiments, the processing system 800 is a computer, laptop/notebook, mobile device, gaming device, wearable computing device, server, or any of various other types of computing systems or devices. It is noted that the number of components of the processing system 800 varies from embodiment to embodiment. In at least some embodiments, there is more or fewer of each component/subcomponent than the number shown in FIG. 8. It is also noted that the processing system 800, in at least some embodiments, includes other components not shown in FIG. 8. Additionally, in other embodiments, the processing system 800 is structured in other ways than shown in FIG. 8.

In some embodiments, the apparatus and techniques described above are implemented in a system including one or more integrated circuit (IC) devices (also referred to as integrated circuit packages or microchips), such as the processing system described above with reference to FIGS. 1-8. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
comparing a first probability density function (PDF) for a first pixel and a second PDF for a second pixel to obtain a similarity of the first PDF and the second PDF;
reusing samples from the first pixel for resampling rays to select a set of samples comprising rays that intersect subsets of path space at the second pixel based on the similarity; and
rendering a first frame based on the selected set of samples.

2. The method of claim 1, wherein comparing comprises:
approximating the first PDF with a first von Mises-Fisher (vMF) distribution;
approximating the second PDF with a second vMF distribution; and
computing a similarity of the first vMF distribution and the second vMF distribution.

3. The method of claim 2, wherein the first vMF distribution is based on a weighted average of past sample directions for the first pixel and the second vMF distribution is based on a weighted average of past sample directions for the second pixel.

4. The method of claim 1, wherein reusing samples comprises reducing an amount of spatial reuse of samples from the first pixel based on the similarity.

5. The method of claim 4, wherein reusing samples further comprises:
applying weights to the samples from the first pixel for resampled importance sampling based on the similarity.

6. The method of claim 5, wherein reusing samples further comprises:
computing an average direction of rays that intersect subsets of path space at the second pixel based on a sum of weighted directions divided by a sum of weights.

7. The method of claim 1, wherein the first pixel spatially neighbors the second pixel.

8. A non-transitory computer readable medium embodying a set of executable instructions, the set of executable instructions to manipulate at least one processor to:
compare a first probability density function (PDF) for a first pixel and a second PDF for a second pixel to obtain a similarity of the first PDF and the second PDF;
reuse samples from the first pixel for resampling rays to select a set of samples comprising rays that intersect subsets of path space at the second pixel based on the similarity; and
render a first frame based on the selected set of samples.

9. The non-transitory computer readable medium of claim 8, wherein the at least one processor is to:
approximate the first PDF with a first von Mises-Fisher (vMF) distribution;
approximate the second PDF with a second vMF distribution; and
compute a similarity of the first vMF distribution and the second vMF distribution.

10. The non-transitory computer readable medium of claim 9, wherein the first vMF distribution is based on a weighted average of past sample directions for the first pixel and the second vMF distribution is based on a weighted average of past sample directions for the second pixel.

11. The non-transitory computer readable medium of claim 8, wherein the at least one processor is to:
reduce an amount of spatial reuse of samples from the first pixel based on the similarity.

12. The non-transitory computer readable medium of claim 11, wherein the at least one processor is to:
apply weights to the samples from the first pixel for resampled importance sampling based on the similarity.

13. The non-transitory computer readable medium of claim 12, wherein the at least one processor is to:
compute an average direction of rays that intersect subsets of path space at the second pixel based on a sum of weighted directions divided by a sum of weights.

14. The non-transitory computer readable medium of claim 8, wherein the first pixel spatially neighbors the second pixel.

15. A device comprising:
a memory to store a plurality of light sources having rays that intersect a set of sampling locations at a first pixel; and
a processor coupled to the memory to:
compare a first probability density function (PDF) for a first pixel and a second PDF for a second pixel to obtain a similarity of the first PDF and the second PDF;
reuse samples from the first pixel for resampling rays to select a set of samples comprising rays that intersect subsets of path space at the second pixel based on the similarity; and
render a first frame based on the selected set of samples.

16. The device of claim 15, wherein the processor is to:
approximate the first PDF with a first von Mises-Fisher (vMF) distribution;
approximate the second PDF with a second vMF distribution; and
compute a similarity of the first vMF distribution and the second VMF distribution.

17. The device of claim 16, wherein the first vMF distribution is based on a weighted average of past sample directions for the first pixel and the second vMF distribution is based on a weighted average of past sample directions for the second pixel.

18. The device of claim 15, wherein the processor is to:
reduce an amount of spatial reuse of samples from the first pixel based on the similarity.

19. The processor of claim 18, wherein the processor is to:
apply weights to the samples from the first pixel for resampled importance sampling based on the similarity.

20. The device of claim 18, wherein the processor is to:
compute an average direction of rays that intersect subsets of path space at the second pixel based on a sum of weighted directions divided by a sum of weights.
